(19) United States
(12) Patent Application Publication
(10) Pub. No.: US 2026/0115511 A1
(43) Pub. Date: Apr. 30, 2026

(54) ELECTRIC VEHICLE FIRE SPREAD PREVENTION SYSTEM

(71) Applicant: Hyunsoo Hong, Incheon (KR)

(72) Inventor: Hyunsoo Hong, Incheon (KR)

(21) Appl. No.: 19/315,284

(22) Filed: Aug. 29, 2025

(30) Foreign Application Priority Data
Oct. 29, 2024 (KR) 10-2024-0149797

(51) Int. Cl. A62C 3/07; A62C 3/16; A62C 8/06; A62C 37/36; A62C 37/38

(52) U.S. Cl. CPC A62C 3/07; A62C 3/16; A62C 8/06; A62C 37/04; A62C 37/38

(57) ABSTRACT

An electric vehicle fire spread prevention system according to an embodiment disclosed herein includes a pair of base frames installed at spaced-apart positions, fixing brackets respectively installed at the front end and rear end of the pair of base frames, a plurality of support ribs installed between the pair of base frames and rotatably mounted to the fixing brackets, and a fire-suppressing blanket coupled to the plurality of support ribs and configured to be folded and unfolded, wherein at least one of the plurality of support ribs is provided with a spray nozzle configured to spray fire-extinguishing water into a space closed off by the fire-suppressing blanket, and wherein at least one of the plurality of support ribs is provided with an operation ring configured to switch the fire-suppressing blanket from an open state to a closed state.

### CROSS REFERENCE TO RELATED APPLICATION

The present application claims the right of priority to and the benefits of Korean Application No. 10-2024-0149797 having a filing date of Oct. 29, 2024, the content of which is hereby incorporated by reference in its entirety.

### TECHNICAL FIELD

The present invention relates to an electric vehicle fire spread prevention system, and more particularly to an electric vehicle fire spread prevention system which, when a fire occurs in an electric vehicle during charging or parking, a fire-suppressing blanket is deployed by means of a plurality of support ribs to surround the exterior of the electric vehicle, such that the vehicle in which the fire has occurred is placed in an isolated space, thereby minimizing the spread of heat and smoke caused by the fire.

### BACKGROUND OF THE INVENTION

In an electric vehicle, the most important component is the battery, which incorporates a plurality of battery modules to enable long-term use with a single charge. The plurality of battery modules are configured as a single battery pack and are mounted on the underside of the vehicle.

The battery pack may catch fire due to various causes, including external impacts. Such a fire may occur while driving or charging.

As described above, the battery used in an electric vehicle is densely arranged with high-capacity cells and is manufactured and installed in a sealed form, so as to minimize damage or problems caused by physical impacts. Therefore, in the event of a fire, penetration of a fire-extinguishing agent is difficult, making suppression of the fire problematic.

Accordingly, when a fire occurs in an electric vehicle, the flames exposed to the outside can only be suppressed with fire-extinguishing water. In particular, when the separator that separates the cathode and anode materials in the battery loses its original function and the cathode and anode materials come into contact with each other, heat is generated, and flammable gases are produced by a chemical chain reaction. Thereafter, as the chemical chain reaction progresses, large quantities of toxic gases, including carbon monoxide, and flammable gases are rapidly generated in large quantities together with extreme temperatures, and the battery ignites and explodes due to sparks.

In particular, when one of the cells is subjected to a physical impact and explodes, the explosion applies a physical impact to adjacent cells, causing sequential thermal runaway propagation and leading to successive explosions of the adjacent cells, which makes fire suppression extremely difficult.

Moreover, electric vehicle batteries have a large capacity that enables long-term use with a single charge. For example, the battery of a mid-sized electric vehicle stores enough electricity to supply an ordinary household for two days. When a fire occurs in such a large-capacity battery, the temperature rises to extremely high levels, so high as to make temperature control difficult, and the fire spreads to nearby facilities, escalating the damage.

In addition, as described above, a fire in an electric vehicle occurs mainly in the battery, which is installed in a sealed form. Since toxic gases and flammable gases are discharged and high temperatures are generated, it is difficult to spray a fire-extinguishing agent or water directly onto the ignition point, and fire-extinguishing water tends to be applied only to the gases or flames exposed outside. This results in not extinguishing the fire itself, but merely preventing the spread of the fire. According to statistics, approximately 28,000 gallons of water are required to completely extinguish a fire in a single electric vehicle. This amount is similar to the quantity of water typically used by one fire station in a month, and thus a substantial social cost is incurred.

In addition, as described above, the battery of an electric vehicle is mainly installed on the underside of the vehicle, and therefore there is a risk of electric shock and explosion due to water sprayed during a fire. Accordingly, completely extinguishing the fire using conventional water-spraying methods is difficult.

### SUMMARY OF THE INVENTION

The present invention has been proposed to solve the above problems. An object of the present invention is to minimize the spread of toxic and flammable gases and heat to the outside by deploying a fire-suppressing blanket surrounding the exterior of an electric vehicle when a fire occurs during charging or parking, thereby isolating the burning electric vehicle in an isolated space.

Another object of the present invention is to improve space utilization and minimize inconvenience in daily life by being configured so that the fire-suppressing blanket can be stored in a folded state on one side of a parking lot or charging facility for rapid deployment when necessary.

A further object of the present invention is to allow the electric vehicle in which a fire has occurred to be isolated in an isolated space by deploying the fire-suppressing blanket from a remote location after a fire has occurred.

Another embodiment is configured to be mobile so that rapid isolation measures can be initiated to minimize the spread of toxic and flammable gases and heat when a fire occurs in an adjacent area.

Embodiments of the present disclosure provide an electric vehicle fire spread prevention system, comprising: a pair of base frames installed at spaced-apart positions; fixing brackets respectively installed at the front end and rear end of the pair of base frames; a plurality of support ribs installed between the pair of base frames, each of longitudinal ends of the support ribs being rotatably mounted to the fixing brackets; and a fire-suppressing blanket coupled to the plurality of support ribs, configured to be folded and unfolded, and configured to prevent the spread of flames, wherein at least one of the plurality of support ribs is provided with a spray nozzle configured to spray fire-extinguishing water, which is supplied from a fire hydrant, into a space closed off by the fire-suppressing blanket, and wherein at least one of the plurality of support ribs is provided with an operation ring configured to switch the fire-suppressing blanket from an open state to a closed state in the event of a fire.

In an embodiment, the electric vehicle fire spread prevention system further comprises an emergency closing mechanism including a rod extending in a longitudinal direction and a hook provided at one longitudinal end of the rod and configured to be hooked onto the operation ring to switch the fire-suppressing blanket to the closed state.

In an embodiment, each of the support ribs comprises: a pair of posts formed in a straight direction and disposed at spaced-apart positions; and a support portion coupled to the pair of posts and bent in a II-shape, wherein each post comprises two or more segmented parts, and a first elastic spring and a first hinge are disposed at a junction between the two or more segmented parts such that, when the support rib comes into contact with an external ceiling or obstacle during movement, the post is foldable by the first elastic spring and the first hinge to allow passage, and when the support rib passes the ceiling or obstacle, the post is restored to its original state by a restoring force of the first elastic spring, wherein a second elastic spring and a second hinge are disposed at a junction between the post and the support portion such that the support portion is rotatable relative to the post.

In an embodiment, the support rib may be provided with a detection sensor configured to detect toxic substances or chemicals generated by a fire, or to detect the fire itself.

In an embodiment, the electric vehicle fire spread prevention system may further comprise a plurality of casters configured to enable movement and stopping of the pair of base frames.

In an embodiment, the electric vehicle fire spread prevention system may further comprise a storage housing in which the pair of base frames and the plurality of support ribs are accommodated, with the plurality of support ribs being arranged in a mutually adjacent state. The storage housing may include: a cover configured to open and close one end of a storage space; and an elastic member disposed in the storage space, having one end in contact with one of the plurality of support ribs and the other end in contact with an inner surface defining the storage space, configured to provide an elastic force to push the plurality of support ribs outward from the storage space.

### BRIEF DESCRIPTION OF THE DRAWINGS

FIG. 1 is a perspective view illustrating an electric vehicle fire spread prevention system according to an embodiment of the present invention.

FIGS. 2A and 2B are perspective views illustrating a base frame according to an embodiment of the present invention.

FIG. 3 is a perspective view illustrating a support rib according to an embodiment of the present invention.

FIG. 4 is a perspective view illustrating a deployed state of the support rib according to an embodiment of the present invention.

FIG. 5 is an exploded perspective view illustrating a storage housing according to an embodiment of the present invention.

FIG. 6 is an exemplary view illustrating a fire-suppressing blanket according to an embodiment of the present invention.

FIG. 7 is a perspective view illustrating a support rib according to another embodiment of the present invention.

FIGS. 8A and 8B are views illustrating another embodiment of the present invention.

### DETAILED DESCRIPTION OF THE INVENTION

Embodiments of the present disclosure are illustrated for the purpose of explaining the technical idea of the present disclosure. The scope of the rights according to the present disclosure is not limited to the embodiments presented below or the detailed descriptions of such embodiments.

As used in the present disclosure, expressions such as “comprising”, “including”, “having”, and the like are to be understood as open-ended terms having the possibility of encompassing other embodiments, unless otherwise mentioned in the phrase or sentence containing such expressions.

The singular form described in the present disclosure may include a plural meaning, unless otherwise mentioned. This applies equally to the singular form recited in the claims.

The terms “first”, “second”, and the like used in the present disclosure are used to distinguish a plurality of components from one another, and do not limit the order or importance of the corresponding components.

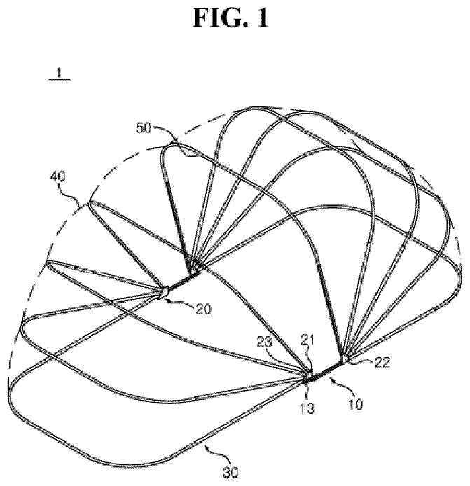

Referring to FIG. 1, an electric vehicle fire spread prevention system 1 according to an embodiment of the present invention includes: a pair of base frames 10 installed symmetrically at mutually spaced positions; fixing brackets 20 respectively installed at the front and rear ends of the pair of base frames 10; a plurality of support ribs 30 installed between the pair of base frames 10, opposite longitudinal ends of each support rib being rotatably mounted to the fixing brackets 20; and a fire-suppressing blanket 40 coupled to the plurality of support ribs 30, the blanket being configured to fold and unfold and to prevent the spread of flames.

The pair of base frames 10 may be disposed symmetrically at mutually spaced positions. The base frames 10 may be formed in a tubular shape extending in the longitudinal direction. Opposite ends of the support ribs 30 are rotatably mounted to the base frames 10.

Each of the pair of base frames 10 may be formed in a rectangular tubular shape extending in the longitudinal direction. Each base frame 10 is provided with a plurality of coupling holes 12 into which fixing brackets 20, described later, are coupled.

The base frames 10 may also be configured in embodiments other than the embodiment formed in the rectangular tubular shape described above. In another embodiment, the base frame is made of a metal material having a predetermined strength capable of supporting a load pressure transmitted from above and includes a bottom plate (not shown) that increases a contact area with an installed floor or ground to provide upright stability.

The thickness and length of the base frames 10 may be varied depending on the arrangement interval and number of the plurality of support ribs 30, described later, and are not limited to the illustrated embodiment.

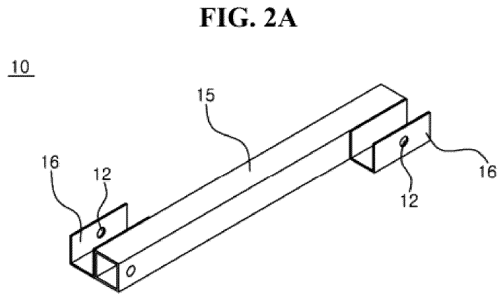

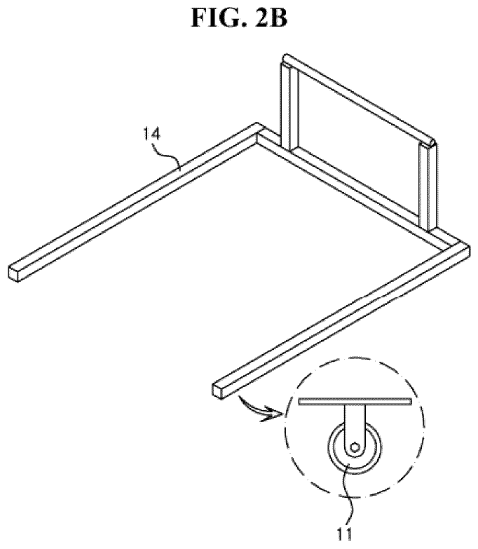

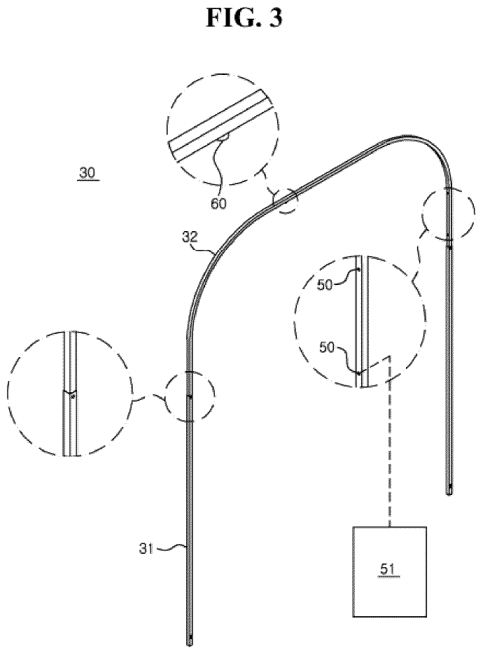

Referring to FIG. 2A, the base frames 10 may include a main frame 15 extending in the longitudinal direction, and a pair of auxiliary frames 16 disposed in opposite directions at opposite longitudinal ends of the main frame 15, each auxiliary frame having a fixing bracket 20 mounted thereto.

The auxiliary frames 16 may be formed in an open-top structure. After the fixing brackets 20 are fitted into the auxiliary frames 16 from above, the auxiliary frames 16 and the fixing brackets 20 may be integrally fixed to each other by welding or fixing bolts.

The pair of base frames 10 may be provided with a plurality of casters 11 configured to enable movement and stopping of the pair of base frames 10. By moving the base frames 10, the casters 11 allow the electric vehicle fire spread prevention system 1 to be rapidly relocated even when a fire occurs at an adjacent location.

In addition, by moving the base frames 10 via the casters 11, the convenience of changing the installation position or storing the system can be improved.

Referring to FIG. 2B, the casters 11 may be provided on a moving frame 14 configured separately from the base frames 10. The moving frame 14 may be formed by mutually coupling a plurality of pipes so that the base frames 10 and the support ribs 30, described later, are seated on an upper surface thereof.

The fixing brackets 20 are installed on the base frames 10. The support ribs 30 are rotatably mounted to the fixing brackets 20. The fixing brackets 20 may be integrally fixed to the coupling holes 12 formed in the base frames 10 by fixing bolts. Each fixing bracket 20 may be provided with a plurality of hinge holes 23 spaced apart from each other, to which the support ribs 30 are rotatably coupled.

The fixing brackets 20 are fixed to the opposite longitudinal ends of the base frames 10. The positions of the hinge holes 23 may vary depending on the positions at which the fixing brackets 20 are fixed to the base frames 10.

Specifically, the fixing brackets 20 include a front bracket 21 installed at the front end in the longitudinal direction of the base frames 10, and a rear bracket 22 installed at the rear end in the longitudinal direction of the base frames 10. The front bracket 21 is fixed to the front end of the base frames 10 and may be made of the same material as the base frames 10. The front bracket 21 may be coupled to a reinforcing plate 13 integrally fixed to the base frames 10 by welding.

Here, the reinforcing plates 13 may be fixed to the sides of the pair of facing base frames 10. The reinforcing plates 13 support and distribute vibrations and impacts that occur during the unfolding of the plurality of support ribs 30 when such vibrations and impacts are transmitted to the base frames 10.

The rear brackets 22 are installed at the rear ends in the longitudinal direction of the base frames 10. The rear brackets 22 may be configured such that a pair of members are disposed so as to abut opposite side surfaces of the base frames 10, and after being fixed by fastening bolts to support loads transmitted during the folding and unfolding of the plurality of support ribs 30, the support ribs 30 are arranged between the pair of members.

Here, when referring to the front ends in the longitudinal direction of the base frames 10, the forward direction means the direction in which a vehicle enters, based on the electric vehicle fire spread prevention system 1. When referring to the rear ends in the longitudinal direction of the base frames 10, the rearward direction means the direction opposite to the forward direction, that is, the direction in which the fire-suppressing blanket 40 is stored in a folded standby state.

The plurality of support ribs 30 are rotatably mounted to the pair of fixing brackets 20. The fire-suppressing blanket 40 is coupled to the plurality of support ribs 30. The plurality of support ribs 30 may fold and unfold the fire-suppressing blanket 40.

The plurality of support ribs 30 may each be formed as a tubular body extending in the longitudinal direction. The plurality of support ribs 30 may be formed in a II-shape so as to form a predetermined space with the ground when the fire-suppressing blanket 40 is unfolded.

Each of the support ribs 30 has a predetermined strength and load capacity so as to support the load pressure of the fire-suppressing blanket 40 and to maintain its installed position even under high-temperature air caused by a fire. Each of the support ribs 30 is made of a metal material having a high melting point so as not to melt even under the extreme heat generated by a battery fire.

In addition, as illustrated in the drawings, the support ribs 30 may be formed by bending a rectangular tubular cross-section so as to have a predetermined strength. However, this is merely one embodiment, and the cross-sectional shape of the support ribs 30 may be variously modified as long as the required strength is maintained.

The plurality of support ribs 30 may be rotatably mounted to the hinge holes 23 formed in the front brackets 21 and the rear brackets 22.

One or more of the plurality of support ribs 30 may be provided with a spray nozzle 50 configured to spray fire-extinguishing water, supplied from a fire hydrant, into a space enclosed by the fire-suppressing blanket 40.

For example, the spray nozzle 50 may be disposed on one of the support ribs 30 that extends across the longitudinal center of the fire-suppressing blanket 40 when the plurality of support ribs 30 are unfolded and the fire-suppressing blanket 40 is deployed.

The support ribs 30 may be formed as hollow tubular bodies. One end of each support rib 30 may be connected via a connecting pipe to a water tank 51 storing fire-extinguishing water, so as to receive the fire-extinguishing water. The fire-extinguishing water delivered to one end of the support rib 30 may then be discharged downward through the spray nozzle 50.

A plurality of spray nozzles 50 may be arranged along the longitudinal direction of the support rib 30. The plurality of spray nozzles 50 may be disposed at positions spaced apart along the longitudinal direction of the support rib 30.

One of the plurality of support ribs 30 may be provided with a detection sensor 60 configured to detect toxic substances or harmful chemicals generated when a fire occurs in a vehicle being charged or parked. In addition, one of the plurality of support ribs 30 may be provided with a detection sensor 60 configured to detect a fire.

The detection sensor 60 is configured to detect a fire occurring in an electric vehicle while the vehicle is parked or being charged. The detection sensor 60 may include at least one of: a temperature sensor configured to detect temperature; a smoke sensor configured to detect smoke exposed to the outside when a fire occurs; a carbon dioxide sensor configured to detect a concentration of carbon dioxide in the air; and a flame sensor configured to detect the presence of a flame.

The electric vehicle fire spread prevention system 1 may include an alarm unit (not shown) configured to provide an external notification by sound or light upon detection of a fire based on values received from the detection sensor 60. The system 1 may also include a control unit (not shown) configured to control the operation of the alarm unit.

The support ribs 30 may comprise a pair of posts 31, formed linearly and arranged in a spaced-apart manner, and a support portion 32 coupled to the pair of posts 31 and bent into a II-shape form.

In one embodiment, the posts 31 and the support portion 32 may be integrally fixed to each other by fastening bolts. Manufacturing the posts 31 and the support portion 32 separately improves convenience in fabrication, transportation, and assembly.

In another embodiment, the posts 31 may be configured to allow length adjustment in the vertical direction, and the support portion 32 may be configured to allow length adjustment in the horizontal direction. This enables adaptation to different installation environments and various fire-suppressing blankets.

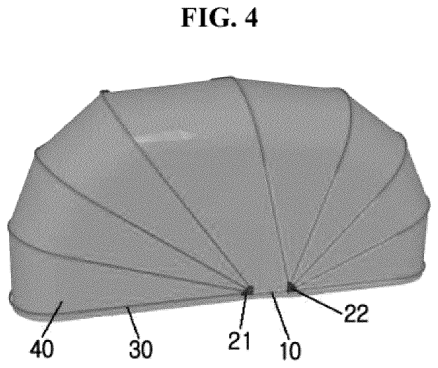

Referring to FIG. 4, the fire-suppressing blanket 40 may be made of a non-combustible material such as fiberglass or silica. The blanket 40 functions to block oxygen within a closed space, thereby eliminating the essential condition for combustion.

The fire-suppressing blanket 40 may have a heat resistance rating in the range of 1000 to 1400° C. and a thickness of 0.3 mm±0.1 mm. A user may cover an electric vehicle on fire with the fire-suppressing blanket 40. The fire-suppressing blanket 40 is coupled to the plurality of support ribs 30 and is folded or unfolded by rotation of the support ribs 30.

A handle 41 configured to be gripped during folding or unfolding of the fire-suppressing blanket 40 may be provided on the support rib 30. The handle 41 may be mounted on the foremost one of the plurality of support ribs 30 to which the fire-suppressing blanket 40 is coupled.

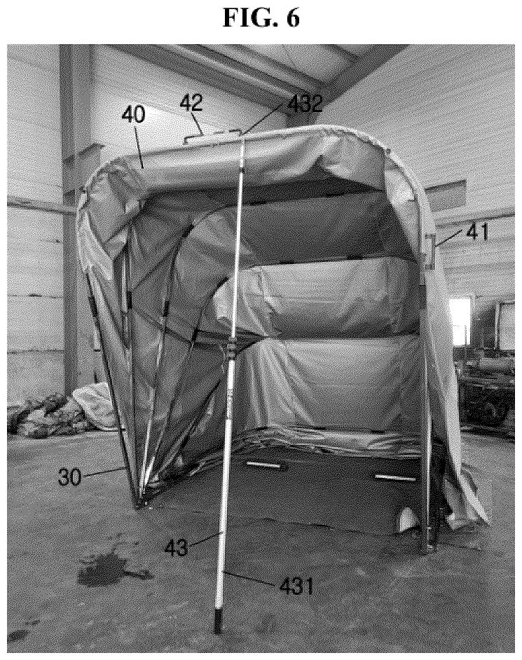

When a fire occurs in an electric vehicle, it may be difficult to directly grasp the handle 41 to deploy the fire-suppressing blanket 40 due to the presence of toxic gases, flammable gases, high-temperature flames, and heat around the electric vehicle. To address this issue, as shown in FIG. 6, an operation ring 42 for changing the fire-suppressing blanket 40 from an open state to a closed state may be provided. The electric vehicle fire spread prevention system 1 may further include an emergency closing mechanism 43. The emergency closing mechanism 43 may include a rod 431 extending in the longitudinal direction and a hook 432 provided at one longitudinal end of the rod 431 and configured to be hooked onto the operation ring 42 to change the fire-suppressing blanket 40 to the closed state.

The operation ring 42 may be provided at the upper end of the foremost support rib 30 among the plurality of support ribs 30.

The emergency closing mechanism 43 may include a telescopic rod 431 extending in the longitudinal direction with an adjustable length, and a hook 432 detachably coupled to one longitudinal end of the rod 431, the tip of the hook being bent so as to be engageable with the operation ring 42.

The electric vehicle fire spread prevention system 1 may be installed in a parking lot or charging station. When a fire occurs in a parked or charging electric vehicle, the fire-suppressing blanket 40 may be moved to the fire location or deployed at the location where it is installed, thereby covering the electric vehicle on fire and blocking inflow of external air.

Meanwhile, in a parking lot or charging station, the fire-suppressing blanket 40 may remain partially deployed in a standby state. In this case, during parking of an electric vehicle, the vehicle may collide with the support rib 30 supporting the fire-suppressing blanket 40, causing the support rib 30 to bend or break.

In addition, when the fire-suppressing blanket 40 is exposed to the outside for an extended period, foreign substances and moisture may adhere to its surface, resulting in poor aesthetics. Furthermore, the foreign substances and moisture adhered to the fire-suppressing blanket 40 may accumulate, and, in the event of a fire, such accumulated substances may ignite due to flames and produce toxic gases, thereby causing additional problems.

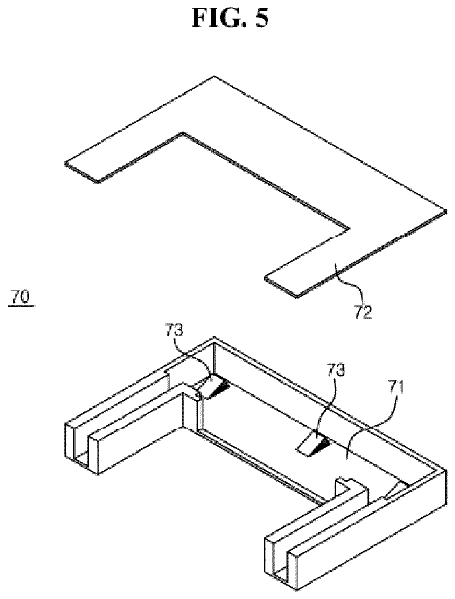

Accordingly, the electric vehicle fire spread prevention system 1 may be configured to store the fire-suppressing blanket 40 in a storage state when not in use, and to deploy it externally when needed. Referring to FIG. 5, the electric vehicle fire spread prevention system 1 may include a storage housing 70 in which the base frame 10 and the plurality of support ribs 30 are accommodated in a mutually adjacent state within a storage space 71. The storage housing 70 may include: a cover 72 configured to open or close one end of the storage space 71; and an elastic member 73 disposed in the storage space 71, having one end in contact with one of the plurality of support ribs 30 and the other end in contact with an inner surface of the storage space 71, thereby providing an elastic force that pushes the plurality of support ribs 30 outward from the storage space 71.

In one example, the storage housing 70 may be formed in a shape corresponding to the shape of the support ribs 30. In another example, the storage housing 70 may be formed in a shape configured to accommodate only a portion of the fire-suppressing blanket 40.

The storage housing 70 may be formed as a housing having the storage space 71 for accommodating the plurality of support ribs 30 in a mutually adjacent state. The storage housing 70 may have an open upper end to form an entrance and exit through which the support ribs 30 and the fire-suppressing blanket 40 move in and out.

The cover 72 may be configured to open or close the entrance of the storage housing 70, and one end thereof may be rotatably mounted to the storage housing 70.

A plurality of elastic members 73 may be disposed at spaced-apart positions within the storage space 71 so as to provide an elastic force that pushes the support ribs 30 outward from the storage space 71.

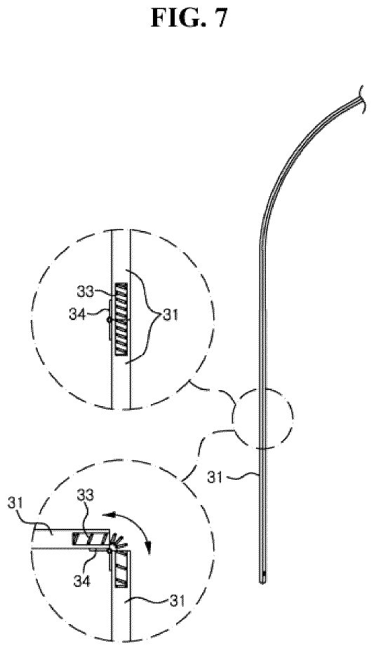

Meanwhile, FIG. 7 illustrates another embodiment of the present invention, which is designed to enable the opening operation of the electric vehicle fire spread prevention system 1 in environments with a low ceiling height. In this embodiment, the post 31 of the support rib 30 may include two or more segmented parts. An elastic spring 33 and a hinge 34 may be disposed at the junction between the segmented parts so that the parts can be folded with respect to each other and then restored. Accordingly, when the support rib 30 comes into contact with a ceiling or another obstacle while moving in a low-ceiling environment, the post 31 may fold by means of the elastic spring 33 and the hinge 34 so as to allow passage, and once the support rib 30 passes the ceiling or another obstacle, the post 31 may be restored to its original state by the restoring force of the elastic spring 33.

The elastic spring 33 and the hinge 34 may be disposed on the contact surface between the post 31 and the support portion 32, such that the support portion 32 is rotatable relative to the post 31. The junction between the post 31 and the support portion 32 may thus include the elastic spring 33 and the hinge 34. When the support rib 30 comes into contact with an external ceiling during movement, the support portion 32 may rotate relative to the post 31 via the elastic spring 33 and the hinge 34, and once the support rib 30 passes the ceiling, the support portion 32 may return to its original state relative to the post 31 by the restoring force of the elastic spring 33.

This embodiment may be applied, for example, in environments with a low ceiling height of 2.3 m or less. In the event of a fire occurring in a vehicle parked or being charged in such a low-ceiling environment, the fire-suppressing blanket of the present invention, which is maintained in a folded standby state, may be deployed to wrap around the exterior of the burning vehicle, thereby minimizing the inflow of external air.

During this process, deployment may be obstructed if the support portion 32 comes into contact with the ceiling. In addition, movement may be hindered by obstacles such as other vehicles or pillars, or the system may need to be transported in a horizontally laid-down state, thereby increasing the time required for movement. To address these problems, the post 31 may be configured to be foldable and restorable, or the post 31 and the support portion 32 may be configured to be foldable and restorable relative to each other, by means of the elastic spring 33 and the hinge 34. As a result, movement and deployment of the fire-suppressing blanket can be facilitated even in low-ceiling environments.

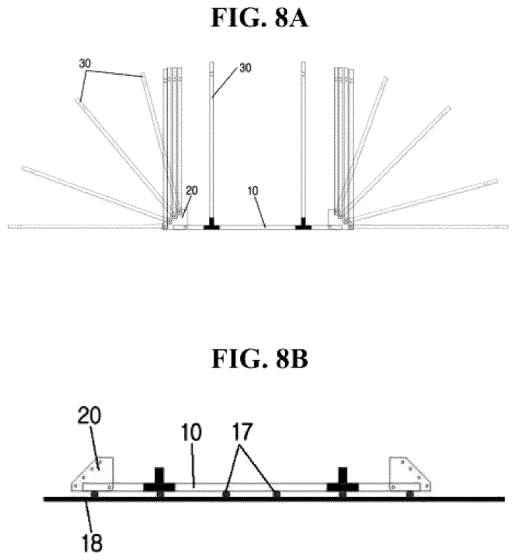

FIGS. 8A and 8B illustrate another embodiment of the present invention, in which the electric vehicle fire spread prevention system is installed in a tandem parking lot, rather than in a front-parking or rear-parking lot, and is configured so that the fire-suppressing blanket covers the exterior of a burning vehicle.

In this embodiment, the base frame 10 may be provided with a plurality of drive wheels 17 to allow movement in a tandem parking lot. A travel rail 18 may be installed on the ground along a designated path to guide the movement of the base frame 10, with the drive wheels 17 arranged to move thereon.

The plurality of support ribs 30 may be configured to fold or unfold forward and backward from the base frame 10. In a folded state of the plurality of support ribs 30, the front and rear of the support ribs 30 may be connected so that a vehicle can pass under the support ribs 30.

Referring to FIGS. 8A and 8B, the plurality of support ribs 30 may be symmetrically arranged at both longitudinal ends of the base frame 10. In a folded state of the plurality of support ribs 30, a vehicle may pass through the front or rear of the electric vehicle fire spread prevention system. After the vehicle has passed and the base frame 10 is positioned at the longitudinal center of the vehicle, the plurality of support ribs 30 disposed at both ends of the base frame 10 may be deployed, thereby deploying the fire-suppressing blanket 40 coupled to the support ribs 30 so as to isolate the burning vehicle from the external environment.

According to an embodiment of the present invention, by placing a burning electric vehicle in an isolated space, the spread of flue gases, flammable gases, and heat generated by the fire may be minimized, thereby reducing fire-related damage.

In addition, an embodiment of the present invention may be provided with a plurality of support ribs configured to be foldable and unfoldable and a fire-suppressing blanket connected thereto, wherein the support ribs may be kept in a folded state during normal times to improve space utilization, and may be quickly unfolded in the event of a fire, thereby enhancing ease of use.

Furthermore, an embodiment of the present invention may be configured to be movable, thereby enabling responses to fires occurring at adjacent locations. Even after a fire breaks out, the fire-suppressing blanket may be deployed while reducing damage caused by high heat, thus providing an advantage.

In addition, an embodiment of the present invention may be provided with spray nozzles on one or more of the support ribs, the nozzles being capable of spraying fire-extinguishing water, thereby improving the efficiency of fire suppression and preventing the fire from spreading.

In addition, an embodiment of the present invention may minimize contamination caused by foreign substances and moisture while in a non-deployed state when the system is in a non-deployed state, thereby reducing the costs required for maintenance.

The technical idea of the present disclosure has been described heretofore with reference to some embodiments and examples illustrated in the accompanying drawings. However, it is to be understood that various substitutions, modifications, and alterations may be made without departing from the technical idea and scope of the present disclosure that can be understood by those of ordinary skill in the technical field to which the present disclosure pertains. In addition, it is to be understood that such substitutions, modifications, and alterations fall within the scope of the appended claims.

What is claimed is:

1. An electric vehicle fire spread prevention system, comprising:
a pair of base frames installed at spaced-apart positions;
fixing brackets respectively installed at the front end and rear end of the pair of base frames;
a plurality of support ribs installed between the pair of base frames, each of longitudinal ends of the support ribs being rotatably mounted to the fixing brackets; and
a fire-suppressing blanket coupled to the plurality of support ribs, configured to be folded and unfolded, and configured to prevent the spread of flames,
wherein at least one of the plurality of support ribs is provided with a spray nozzle configured to spray fire-extinguishing water, which is supplied from a fire hydrant, into a space closed off by the fire-suppressing blanket,
wherein at least one of the plurality of support ribs is provided with an operation ring configured to switch the fire-suppressing blanket from an open state to a closed state in the event of a fire,
wherein the electric vehicle fire spread prevention system further comprises an emergency closing mechanism including a rod extending in a longitudinal direction and a hook provided at one longitudinal end of the rod and configured to be hooked onto the operation ring to switch the fire-suppressing blanket to the closed state,
wherein each of the support ribs comprises:
a pair of posts formed in a straight direction and disposed at spaced-apart positions; and
a support portion coupled to the pair of posts and bent in a II-shape,
wherein each post comprises two or more segmented parts, and
a first elastic spring and a first hinge are disposed at a junction between the two or more segmented parts such that, when the support rib comes into contact with an external ceiling or obstacle during movement, the post is foldable by the first elastic spring and the first hinge to allow passage, and when the support rib passes the ceiling or obstacle, the post is restored to its original state by a restoring force of the first elastic spring, and
wherein a second elastic spring and a second hinge are disposed at a junction between the post and the support portion such that the support portion is rotatable relative to the post.

2. The electric vehicle fire spread prevention system of claim 1, wherein the support rib is provided with a detection sensor configured to detect toxic substances or chemicals generated by a fire, or to detect the fire itself.

3. The electric vehicle fire spread prevention system of claim 1, further comprising a plurality of casters configured to enable movement and stopping of the pair of base frames.

4. The electric vehicle fire spread prevention system of claim 1, further comprising a storage housing in which the pair of base frames and the plurality of support ribs are accommodated, with the plurality of support ribs being arranged in a mutually adjacent state,
wherein the storage housing includes:
a cover configured to open and close one end of a storage space; and
an elastic member disposed in the storage space, having one end in contact with one of the plurality of support ribs and the other end in contact with an inner surface defining the storage space, configured to provide an elastic force to push the plurality of support ribs outward from the storage space.
